(19) United States
(12) Patent Application Publication
(10) Pub. No.: US 2006/0234125 A1
(43) Pub. Date: Oct. 19, 2006

(54) Lithium Ion Rocking Chair Rechargeable Battery

(75) Inventor: Alain Valle, Varennes (CA)

Correspondence Address: OSLER, HOSKIN & HARCOURT, LLP (AVESTOR), 1000 DE LA GAUCHETIERE STREET WEST, SUITE 2100, MONTREAL, QC, H3B-4W5, CA

(73) Assignee: Avestor Limited Partnership, Boucherville (CA)

(21) Appl. No.: 11/279,680

(22) Filed: Apr. 13, 2006

Related U.S. Application Data
(60) Provisional application No. 60/671,486, filed on Apr. 15, 2005.

(51) Int. Cl. H01M 4/58; H01M 4/48

(52) U.S. Cl. 429/231.95; 429/231.1; 429/231.5

(57) ABSTRACT

An electrochemical cell for a lithium ion rechargeable battery. The electrochemical cell comprises an anode including anode active material having a reduction potential of at least about 1.0 volt, a cathode including cathode active material having an oxidation potential of no more than about 3.7 volts, and an electrolyte separator separating the anode and the cathode.

### CROSS REFERENCES TO RELATED APPLICATIONS

The present Utility Patent Application claims priority on U.S. Provisional Application No. 60/671,486 filed Apr. 15, 2005, the content of which is incorporated herein by reference.

### FIELD OF THE INVENTION

The present invention relates generally to lasting lithium ion rocking chair rechargeable batteries and, more particularly, to lithium ion rocking chair rechargeable batteries optimized for large format battery and long cycle life.

### BACKGROUND OF THE INVENTION

Lithium batteries with insertion material at the anode (or negative electrode) and at the cathode (or positive electrode) were termed rocking chair batteries. Rocking chair Li-ion batteries having a liquid or gel electrolyte are mostly based on carbon anodes such as graphite and cathode materials with redox activities around 4 volts such as LiCoO₂, LiMn₂O₄, LiNiO₂ and their derivatives (e.g., LiCoₓNi₍₁₋ₓ₎O₂, LiMn(₂₋ₓ₎MₓO₂ where M=Mg, Al, Cr, Ni, Cu, etc,). In 1990, Sony was the first to commercialize a Li-ion battery based on hard carbon as the anode and a LiCoO₂ cathode. Now Li-ion batteries are commercialized worldwide by a large number of companies and are well adapted for consumer electronic products such as cellular phones and laptop computers. The Li-ion batteries are available in different configurations including spiral wound cylindrical, wound prismatic and flat prismatic in different sizes ranging from 0.1 Ah to 4 Ah.

The performances of a Li-ion battery are very temperature sensitive. For example, the capacity fade may be accelerated by 30 to 50% by operating the battery at temperatures of 40 to 50° C. compared to the same battery operated at temperatures of 20 to 25° C. Li-ion batteries stored at temperatures above 40° C. will similarly suffer important irreversible capacity loss. This temperature sensitivity is related to the evolution of passivation films, called the solid electrolyte interface (SEI) formed on the surface of the electrode active materials.

In a Li-ion battery or cell having a carbon anode, a cathode material having a redox activity around 4 volts, and a non aqueous electrolyte (dry, liquid or gel type), on the very first cycle (charge-discharge), the SEI is formed on the surfaces of the electrode's active materials. This SEI has been shown to result from a reaction of the electrolyte with the active materials surface. This SEI contains lithium that is no longer electrochemically active since it is immobilized in the SEI, thus the formation of this SEI results in irreversible capacity loss of the Li-ion battery or cell. The nature and stability of the SEI are crucial issues governing the performance of a Li-ion cell. The nature of the SEI is dependent upon the nature of the electrolyte (solvents and salt), on the reduction potential of the anode active material and on the oxidation potential of the cathode active material.

On the anode side, for a carbon anode for example, the lithium intercalation and deintercalation takes place at low reduction potential close to the reference voltage Li⁺/Li. At such negative potential, the electrolyte (solvents and salt) is not thermodynamically stable. At a reduction potential of less than 1 Volt, the electrolyte is decomposed at the surface of the carbon anode active material thereby forming the SEI film and consuming a considerable amount of lithium ion resulting in an irreversible capacity loss. The percentage of irreversible capacity loss is mostly related to the nature of the carbon (carbon type, morphology and surface area) and the nature of the electrolyte (solvents and salt).

In order to obtain the highest possible energy density, battery designers have been selecting cathode active materials with the highest oxidation potential. This potential window selection criteria of cathode materials has caused the use of alkyl carbonates solvent because of their good oxidation stability; however these solvents are not thermodynamically stable and react at the surface of the cathode active materials at potentials below 4 volts (REF: M. Moshkovich, M. Cojocaru, H. E. Gottlieb, and D. Aurbach, J. Electroanal. Chem., 497, 84, 2001) which results in the formation of an SEI at the surface of the cathode active materials (REFs: D. Aurbach, M. D. Levi, E. Levi, H. Teller, B. Markosky, G. Salitra, L. Heider, and U. Heider, J. Electrochem. Soc., 145, 359, 2001; D. Aurbach, K. Gamolsky, B. Markosky, G. Salitra and Y. Gofer, J. Electrochem. Soc., 147, 1322, 2000).

The performance failure of Li-ion battery operating or stored at temperatures higher than 40° C. is due to a number of factors (that depend on the nature of the carbon, the nature of the cathode active material and the nature of the electrolyte) which include, as a major factor, the evolution of the SEI on both positive and negative electrode active materials. It is well known by persons skilled in the art that the SEI is very sensitive to the cell temperature. Charging, discharging or storing a Li-ion battery at a temperature over 40° C. will result in the growth of the SEI film on electrode active materials. The resulting effect is an irreversible capacity loss because lithium ion is consumed in the growth of the SEI. The resistance of the electrodes and the cell polarization increases with the growth of the SEI thereby affecting the power capability of the battery or cell and reducing its cycling life.

The negative effects on the performance of Li-ion batteries due to the temperature sensitivity of the SEI limits the utilization of the Li-ion technology in terms of size and energy content. Charging and discharging the battery generates heat that must be dissipated or the battery or cells' overall temperature will rise. Heat generated internally in a cell is usually transferred by conduction to the exterior surfaces of the battery or cell where it is dissipated by conduction or convection. As the battery or cells get larger, the internal distance to transfer heat leads to higher internal battery or cell temperature and therefore growth of the SEI on electrode's active material surfaces which results in battery or cell performances degradation or worst, in the disastrous situation of thermal runaway which can lead to fire and/or explosions. For these reasons, Li-ion battery technology has been limited to small size batteries with proportionately small energy content in which heat dissipation is easily controlled and SEI growth problems are minimized.

### STATEMENT OF INVENTION

The present invention seeks to provide a safe large format lithium ion rocking chair rechargeable battery having a long cycle life.

In accordance with a broad aspect, the invention seeks to provide an electrochemical cell for a lithium ion rechargeable battery. The electrochemical cell comprises an anode including anode active material having a reduction potential of at least about 1.0 volt, a cathode including cathode active material having an oxidation potential of no more than about 3.7 volts, and an electrolyte separator separating the anode and the cathode.

In accordance with another broad aspect, the invention seeks to provide a lithium ion rocking chair rechargeable battery having a capacity of 5 Ah or more comprising at least one anode, at least one cathode, and at least one electrolyte separating the anode and the cathode, wherein the at least one anode has a reduction potential of at least 1.0 volt and the at least one cathode has an oxidation potential of 3.7 volts or less.

The present invention concerns a lithium ion rocking chair rechargeable battery optimized for large battery format and long cycle life, that can be charged, discharged and stored at a temperature over 40° C. without irreversibly affecting the electrochemical performance of the battery (capacity, cycle life and power). The battery is based on an anode active material having a reduction potential of at least 1.0 volt and a cathode active material having an oxidation potential of 3.7 volts or less. Limiting the anode reduction potential to a minimum of 1.0 volt eliminates the reaction of reduction of the electrolyte with the anode active material leading to the formation of an SEI film on the anode active material surface. The resulting SEI free anode is less resistive, does not irreversibly consume any lithium ion and is not affected by temperature of over 40° C. Limiting the cathode oxidation potential to a maximum of 3.7 volts eliminates the reaction of oxidation of the electrolyte with the cathode active material leading to the formation of an SEI film on the cathode active material surface. The resulting SEI free cathode is also less resistive, does not irreversibly consume any lithium ion and is not affected by temperature of over 40°C.

The lithium ion rocking chair rechargeable battery of the present invention having free SEI electrodes is very well adapted for large capacity and long cycling life battery due to its better heat resistance. Heat generated during charge and discharge of the battery or cell will not lead to an increase of the electrodes' resistance caused by the growth of SEI films on the anode or cathode active material surfaces, will not cause irreversible capacity loss, and will not limit the cycling life of the battery or cell. Furthermore, the storage of the battery or cell at temperatures over 40° C. will not lead to an increase of the electrodes' resistance by the growth of SEI films at the anode or cathode active material surfaces, will not cause irreversible capacity loss, and therefore will not limit the cycling life of the battery or cell.

Limiting the voltage of the anode and cathode as suggested above and narrowing the potential difference between the anode and cathode is a unique strategy for battery designers because it reduces the energy density of such a battery. However, it is a design strategy that makes sense for applications that require batteries that can operate or be stored at temperatures that can reach 80° C., without affecting the battery's capacity and cycle life, and where the volume and the weight of the batteries are secondary requirements, i.e. applications such as electrical utilities, industrial, telecommunication and energy storage applications including load leveling, peak shaving, etc. Battery designers systematically adopt the opposite strategy of trying to broaden as much as possible the potential difference between the anode and the cathode in order to achieve the maximum energy per volume and weight. Battery designers invariably select anode active materials with reduction potential as low as possible like the carbon and graphite and cathode active materials with the highest possible oxidation potential like LiCoO₂ with an oxidation potential well above 3.7 volts, and take into account the reduction and oxidation stability of the electrolyte, in order to obtain the maximum energy density in the battery. A design strategy that makes sense for an important number of applications were the available space and weight tolerance are limited such as consumer electronics, satellite applications, electric vehicles, etc. However, the consequence of that type of design strategy is a battery with limited temperature tolerances and limited cycling life, and that needs to be stored in an controlled temperature environment.

According to the selection strategy of the present invention, the anode active material has a reduction potential of at least 1.0 volt and may be selected amongst others, from Li₄Ti₅O₁₂, LiₓNb₂O₅, LiₓTiO₂, etc. and the cathode active material has an oxidation potential of 3.7 volts or less which may be selected amongst others, from LiFePO₄, LiₓV₃O₈, V₂O₅, etc..

Advantageously, the electrolyte may be a polymer, copolymer or terpolymer, solvating or not, optionally plasticized or gelled by a polar liquid containing one or more metallic salt in solution. The electrolyte may also be a polar liquid immobilized in a microporous separator and contain one or several metallic salts in solution. In a specific case, at least one of these metallic salts is a lithium salt.

The polymer used to bond the electrodes or as electrolytes may advantageously be a polyether, polyester, a polymer based on methyl methacrylate units, an acrylonitrile-based polymer and/or a vinyldiene floride, a Styrene butadiene rubber or copolymer or a mixture thereof. The nature of the polymer is not a limitation of the present invention.

The battery according to the present invention can comprise an aprotic solvent e.g. ethylene or propylene carbonate, an alkyl carbonate, γ-butyrolactone, a tetraalkylsulfamide, an α-ω dialkyl ether of mono, di-, tri-, tetra-, or oligo-ethylene glycol with molecular weight less than or equal to 5000, as well as mixtures of the above-mentioned solvents. The nature of the solvent is not a limitation of the present invention.

The metallic salt may be lithium, sodium, potassium salts or others such as for example, salts based on lithium trifluorosulfonimide described in U.S. Pat. No. 4,505,997, cross-linkable or non cross-linkable lithium salts derived from bisperhalogenoacyl or sulfonylimide describe in U.S. Pat. No. 4,818,644, LiPF₆, LiBF₄, LiSO₃CF₃, LiClO₄, LiSCN, LiN(CF₃SO₂)₂, LiC(CF₃SO₂)₃, etc. The nature of the salt is not a limitation of the present invention.

### BRIEF DESCRIPTION OF THE DRAWINGS

The invention will be better understood and other advantages will appear by means of the following description and the following drawings in which:

FIG. 1 is a schematic cross-sectional view of a lithium ion cell configuration in accordance with one non-limiting embodiment of the invention; and

FIG. 2 is a schematic cross-sectional view of a lithium ion cell configuration in accordance with another non-limiting embodiment of the invention.

### DESCRIPTION OF PREFERRED EMBODIMENT(S)

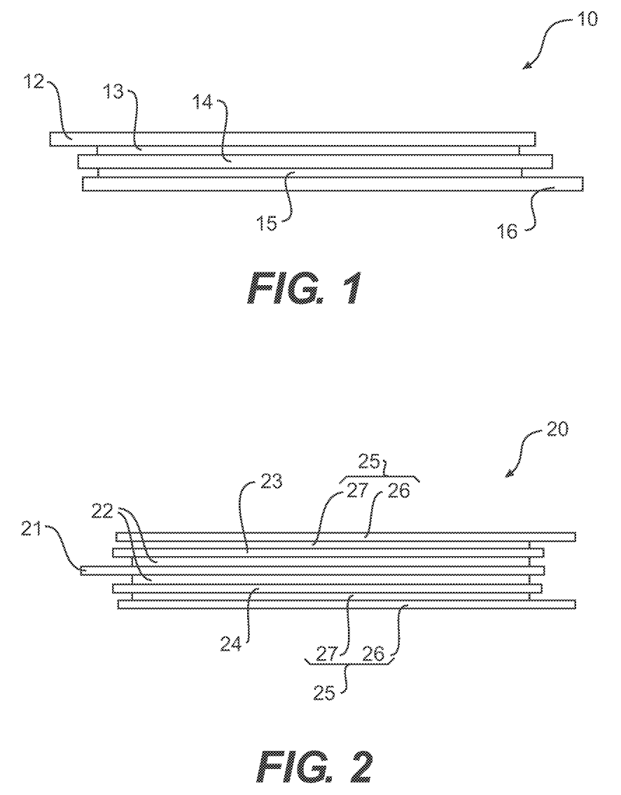

FIG. 1 illustrates a typical Li-ion cell 10 having a mono-face configuration. The Li-ion cell 10 comprises an anode or negative current collector 12 to which is layered an anode 13 consisting of an anode active material bound together with a polymer material and optionally an electronic conductive additive. Li-ion cell 10 further comprises a cathode or positive current collector 16 to which is layered a cathode 15 consisting of a cathode active material bound together with a polymer material and optionally an electronic conductive additive. An electrolyte separator 14 is positioned between the anode 13 and the cathode 15 to electrically isolate anode 13 from cathode 15 yet permit lithium ions to migrate from anode 13 to cathode 15 during discharge and from cathode 15 to anode 13 during charge.

As illustrated, the negative current collector 12 extends from one end of the Li-ion cell 10 and the positive current collector 16 extends from the other end of the Li-ion cell 10 in an offset configuration to allow for easy connection to positive or negative terminals when a plurality of the Li-ion cells 10 are assembled together. The negative current collector 12 may be metallic foil or grid, preferably made of metal or metals that are stable within the voltage range of the electrochemical system such as copper or alloy thereof and aluminum or alloy thereof and the positive current collector 16 may be metallic foil or grid, also preferably made of metal or metals that are stable within the voltage range of the electrochemical system such as aluminum or alloy thereof.

The electrolyte separator 14 can be a polymer, copolymer or terpolymer based electrolyte, plasticized or not, containing one or more metallic salts in solution. The electrolyte separator 14 may also be a polar liquid immobilized in a microporous separator containing one or several metallic salts in solution, at least one of these salts being a lithium salt.

As previously described, the anode active material is selected from materials having a reduction potential of at least 1.0 Volt whereas the cathode active material is selected from materials having an oxidation potential of 3.7 volts or less, thereby eliminating the reduction or oxidation reaction of the electrolyte on the anode or cathode active materials which cause the formation and growth of passivation films that adversely affect the cycling life as well as the overall capacity of the Li-ion cell. Preferred anode active materials are Li₄Ti₅O₁₂, LiₓNb₂O₅, and LiₓTiO₂ and preferred cathode active materials are LiFePO₄, LiₓV₃O₈, V₂O₅.

The preferred selection of active materials consists in combining Li₄Ti₅O₁₂ as the anode active material with LiFePO₄ as the cathode active material. Li₄Ti₅O₁₂ has a reduction potential of more than 1 volt whereas LiFePO₄ has an oxidation potential of less that 3.7 volts. This preferred combination meets the selection criteria outlined above such that a Li-ion cell with this specific combination of anode and cathode active materials can be assembled into large format batteries having a capacity of at least 5.0 Ampere·hour (Ah) and preferably at least 10 Ah. Li-ion cells having a Li₄Ti₅O₁₂ based anode 13 and an LiFePO₄ based cathode 15 may be assembled into large format batteries having capacities of up to 100 Ah, or more, and be able to cycle for very long periods on account of the combination of active materials with stable structures (for insertion and de-insertion of Li ions) associated with the absence of electrolyte oxidation and/or reduction on the surfaces of the active materials.

Li-ion cells 10 having as anode active material, a material having a reduction potential of at least 1.0 volt and as cathode active material, a material having an oxidation potential of 3.7 volts or less, such as an Li₄Ti₅O₁₂ based anode 13 and an LiFePO₄ based cathode 15, may be stacked or wounded into large format batteries having a weight of 5 kg or more, ranging from 5 kg to 100 kg or more. Such Li-ion batteries, assembled Li-ion cells 10 can operate or be stored at temperatures that can reach 80° C. without affecting the capacity of batteries and their cycle life. The energy density of such batteries may be inferior to typical Li-ion configurations, although not necessarily. However, this small setback is far outweighed by the longevity and ability to cycle repeatedly for extended periods of time as well as the inherent temperature resistance of this particular configuration of Li-ion batteries. Furthermore, in stationary applications such as load leveling, peak shaving and utilities where the volume and weight of the batteries is secondary to their ability to reliably and repeatedly deliver power on demand without having to be replaced every 300 to 500 cycles, space to house and accommodate the batteries is relatively easy to find and represents a minor expense compared to the cost of frequent battery replacements. A large battery comprising Li-ion cells 10 in accordance with the present invention can be adapted to cycle a 1000 times and may perform as much as 5000 cycles at 100% DOD (Depth Of Discharge).

FIG. 2 illustrates a Li-ion cell 20 having a bi-face configuration. The Li-ion cell 20 comprises a central positive current collector 21 to which is layered on each of its sides a cathode 22 consisting of a cathode active material bound together with a polymer material and optionally an electronic conductive additive. A pair of electrolyte separators 23 and 24 are layered over each cathode 22. A respective anode assembly 25 consisting of a negative current collector 26 to which is layered an anode material 27, is layered over each electrolyte separator 23 and 24. The bi-face configuration allows to use a single positive current collector 21 for two cathodes 22, thereby marginally increasing energy density by eliminating one current collector. When a plurality of Li-ion cells 20 are assembled together, the weight reduction may be significant.

As previously described for FIG. 1, Li-ion cells 20 comprise anodes 27 having as anode active material, a material having a reduction potential of at least 1.0 volt and cathodes 22 having as cathode active material, a material having an oxidation potential of 3.7 volts or less, such as Li₄Ti₅O₁₂ based anodes 27 and LiFePO₄ based cathodes 22. Li-ion cells 20 may be then stacked or wounded together to form large format batteries having high capacities and long cycling life as well as the ability to withstand wide temperature variations without affecting the capacity of Li-ion cells 20. A Li-ion cell 20 comprising anodes 27 having a reduction potential of at least 1.0 volt and cathodes 22 having an oxidation potential of 3.7 volts or less, such as Li₄Ti₅O₁₂ based anodes 27 and LiFePO₄ based cathodes 22 may operate in a large range of temperatures without affecting their capacity.

Li₄Ti₅O₁₂ as anode active material may also be combined with LiₓV₃O₈ as the cathode active material to meet the selection criteria outlined above. Li₄Ti₅O₁₂ has a reduction potential of more than 1 volt whereas LiₓV₃O₈ has an oxidation potential of less that 3.7 volts. A Li-ion cell with this specific combination of anode and cathode active materials can be assembled into large format batteries having a capacity of at least 5.0 Ah and having an extended cycle life and also be temperature resistant.

Li₄Ti₅O₁₂ as anode active material may also be combined with V₂O₅ as the cathode active material to meet the selection criteria outlined above. Li₄Ti₅O₁₂ has a reduction potential of more than 1 volt whereas V₂O₅ has an oxidation potential of less that 3.7 Volts (≈3.2 volts). A Li-ion cell with this specific combination of anode and cathode active materials can be assembled into large format batteries having a capacity of at least 5.0 Ah and having an extended cycle life.

Other combinations meeting the selection criteria outlined above are: LiₓNb₂O₅/LiFePO₄; LiₓNb₂O₅/LiₓV₃O₈; and LiₓNb₂O₅/V₂O₅; as well as LiₓTiO₂/LiFePO₄; LiₓTiO₂/LiₓV₃O₈; and LiₓTiO₂ and V₂O₅.

Furthermore, ionic liquids such as melted alkali metal salts which have a narrow window of stability comprised between 0.5 volt and 3.6 volts may advantageously be combined with a Lithium-ion cells having as anode active material, a material having a reduction potential of at least 1.0 volt and as cathode active material, a material having an oxidation potential of 3.7 volts or less, such as an Li₄Ti₅O₁₂ based anode and an LiFePO₄ based cathode. The use of ionic liquid as electrolytes has thus far been prohibited by their instability in the voltage range of standard Lithium ion batteries. However, a combination of an Li₄Ti₅O₁₂ based anode and an LiFePO₄ based cathode which has a voltage range of 1.0 volt to 3.7 volt and therefore within the stability window of ionic liquids renders these materials useful as electrolytes.

Although various embodiments have been illustrated, this was for the purpose of describing, but not limiting, the invention. Various modifications will become apparent to those skilled in the art and are within the scope of this invention, which is defined more particularly by the attached claims.

1- A lithium ion rocking chair battery having a capacity of 5 Ah or more, comprising at least one anode, at least one cathode and at least one electrolyte between the anode and the cathode, wherein each of the at least one anode has a reduction potential of at least about 1.0 volt and each of the at least one cathode has an oxidation potential of about 3.7 volts or less.

2- A lithium ion rocking chair battery as defined in claim 1 characterized in that the surface of the active material of the at least one anode and the surface of the active material of the at least one cathode are free from a passivation layer.

3- A lithium ion rocking chair battery as defined in claim 1 characterized in that the anode active material is selected from Li₄Ti₅O₁₂, LiₓNb₂O₅, and LiₓTiO₂.

4- A lithium ion rocking chair battery as defined in claim 3 characterized in that the anode active material is Li₄Ti₅O₁₂.

5- A lithium ion rocking chair battery as defined in claim 1 characterized in that the cathode active material is selected from LiFePO₄, LiₓV₃O₈, and V₂O₅.

6- A lithium ion rocking chair battery as defined in claim 5 characterized in that the cathode active material is LiFePO₄.

7- A lithium ion rocking chair battery as defined in claim 1 characterized in that the electrolyte is a polymer, copolymer or terpolymer, solvating or not, plasticized or gelled by a polar liquid containing at least one metallic salt in solution.

8- A lithium ion rocking chair battery as defined in claim 1 characterized in that the electrolyte is a polymer, copolymer or terpolymer, solvating or not, plasticized or gelled by an aprotic solvent containing at least one metallic salt in solution.

9- A lithium ion rocking chair battery as defined in claim 1 characterized in that the electrolyte is a polar liquid soaked in a microporous separator and containing at least one metallic salt in solution.

10- A lithium ion rocking chair battery as defined in claim 7 characterized in that one of the at least one metallic salt in the electrolyte is a lithium salt.

11- A lithium ion rocking chair battery as defined in claim 8 characterized in that one of the at least one metallic salt in the electrolyte is a lithium salt.

12- A lithium ion rocking chair battery as defined in claim 1 characterized in that the electrolyte is an ionic liquid.

13- A lithium ion rocking chair battery as defined in claim 1 characterized in that the electrolyte is a liquid salt.

14- An electrochemical cell for a lithium ion rocking chair battery, said electrochemical cell comprising:
an anode including anode active material having a reduction potential of at least about 1.0 volt;
a cathode including cathode active material having an oxidation potential of no more than about 3.7 volts;
an electrolyte, and
a separator positioned between said anode and said cathode.
